(19) United States
(12) Patent Application Publication
(10) Pub. No.: US 2025/0037194 A1
(43) Pub. Date: Jan. 30, 2025

(54) ITERATIVE AUCTIONS ROUNDS AND VISUAL DISPLAY OF DATA FOR AUCTION

(71) Applicant: Regional Market Makers, Inc., Palo Alto, CA (US)

(72) Inventors: Fernando Molina Santos, Zempoala (MX); Pedro Javier Noyola de Garagorri, Palo Alto, CA (US)

(21) Appl. No.: 18/771,497

(22) Filed: Jul. 12, 2024

Related U.S. Application Data
(60) Provisional application No. 63/515,572, filed on Jul. 25, 2023.

(51) Int. Cl. G06Q 30/08; G06Q 30/0207

(52) U.S. Cl. CPC G06Q 30/08; G06Q 30/0239

(57) ABSTRACT

In one aspect, the present disclosure also relates to the visual display of data, and more particularly to displaying a dual-axis representation of bids to provide improved guidance to bidders in an auction. In another aspect, the present disclosure relates to an auction technique, and in particular to a combination of a clock auction scheme and a knapsack bidding scheme.

### CROSS-REFERENCE TO RELATED APPLICATIONS

This application claims the benefit of priority to U.S. Application No. 63/515,572, filed on Jul. 25, 2023, the contents of which are hereby incorporated by reference.

### TECHNICAL FIELD

The present disclosure relates to an auction technique, and in particular to a combination of a clock auction scheme and a knapsack allocation scheme.

The present disclosure also relates to the visual display of data, and more particularly to displaying a dual-axis representation of bids to provide improved guidance to bidders in an auction.

### BACKGROUND

An “invoice auction” is an auction in which bidders submit competing bids on the right to pay a discounted amount immediately to the current holder of an invoice in return for the right to collect the full amount of the invoice on its eventual due date. In this context, the “customer” is the entity that bought merchandise or services and will need to pay the invoice, the “supplier” is the entity that received the order and has issued the invoice and is awaiting payment, and the “bidder” is the entity that bids on the opportunity to pay the supplier the discounted amount but eventually receive the full amount of the payment for the invoice from the customer. Typically the supplier has already delivered the merchandise or performed the service when the supplier puts the invoice up for auction but this is not a requirement.

### SUMMARY

In one aspect, one or more computer-readable media store instructions that, when executed by one or more computers of an invoice computer system, cause the one or more computers to
maintain at least one data store defining a respective account for each of a plurality of suppliers, each of a plurality of customers, and each of a plurality of bidders;
receive from a supplier computer system a request to submit one or more invoices for auction;
calculate a total invoice amount for the one or more invoices;
receive a plurality of bids from a plurality of bidder computer systems, each bid including a minimum discount rate and a maximum amount covered;
set an acceptable discount rate equal to an initial discount rate;
set a remaining group of bids to be the plurality of bids;
at a close of bidding, in an iterative loop
   determine whether any bid from the remaining group of bids has a minimum discount rate equal to or greater than the acceptable discount rate,
   if no bid is determined to have a minimum discount rate greater than the acceptable discount rate, then decrement the acceptable discount rate by a bid increment, and repeat the loop,
   if a given bid is determined to have a minimum discount rate equal to or greater than the acceptable discount rate, then
      calculate a total amount covered by summing the maximum amount covered of each bid, other than the given bid, of the remaining group of bids,
      determine whether the total amount covered is equal to or greater than the total invoice amount, remove the given bid from the remaining group of bids,
      if the total amount covered is determined to be equal to or greater than the total invoice amount, then decrement the acceptable discount rate by the bid increment, and repeat the loop,
      if the total amount covered is determined to be less than the total invoice amount, then exit the loop;
allocate the invoices among the one or more bids of the remaining group of bids; and
set a final discount rate to be the acceptable discount rate.

In another aspect, one or more computer-readable media store instructions that, when executed by one or more computers of an invoice computer system, cause the one or more computers to
maintain at least one data store defining a respective account for each of a plurality of suppliers, each of a plurality of customers, and each of a plurality of bidders;
receive from a supplier computer system a request to submit one or more invoices for auction;
receive a plurality of bids from a plurality of bidder computer systems, each bid including a minimum discount rate and a maximum amount covered; and
for each respective bidder of one or more bidders from the plurality of bidders, cause a display of a bidder computer system of the respective bidder to display a dual-axis representation of a multiplicity of currently outstanding bids, the dual axis representation including a first axis representing a discount rate and a second axis representing the maximum amount covered.

In another aspect, one or more computer-readable media storing instructions that, when executed by one or more computers of a computer system, cause the one or more computers to:
maintain at least one data store defining a respective account for each of a plurality of suppliers, each of a plurality of customers, and each of a plurality of bidders;
receive from a supplier computer system a request to submit one or more invoices for auction;
calculate a total invoice amount for the one or more invoices;
receive a plurality of bids from a plurality of bidder computer systems, each bid including a minimum discount rate and a maximum amount covered;
set an acceptable discount rate equal to an initial discount rate;
set a group of remaining bids to be the plurality of bids;
at a close of bidding, in a first iterative loop
   determine whether a bid from the group of remaining bids has a minimum discount rate greater than the acceptable discount rate, and if a given bid is determined to have a minimum discount rate equal to or greater than the acceptable discount rate, then remove the given bid from the group of remaining bids,
   calculate a total amount covered by summing the maximum amount covered of each bid of the group of remaining bids,
   determine whether the total amount covered is equal to or less than the total invoice amount,
   if the total amount covered is determined to be greater than the total invoice amount, then decrease the acceptable discount rate by a first bid increment, and repeat the loop,
   if the total amount covered is determined to be less than or equal to the total invoice amount, then exit the first loop;
allocate the invoices among the one or more bids of the remaining group of bids; and
set a final discount rate to be the acceptable discount rate.

Possible advantages may include, but are not limited to, one or more of the following.

Multiple invoices can be auctioned at once, and different invoices can be allocated to different winning bidders. The discount that each winning bidder provides to the supplier is not less than needed to win the bid, while the supplier receives the best discount from among the multiple bidders.

Presenting a dual-axis representation of other bids permits a bidder to reach better decisions on their own bids.

The details of one or more implementations are set forth in the accompanying drawings and the description below. Other aspects, features, and advantages will be apparent from the description and drawings, and from the claims.

### BRIEF DESCRIPTION OF DRAWINGS

FIG. 1 illustrates an example network to perform an electronic invoice auction.

FIG. 2A illustrates a flow chart of a method of conducting an electronic invoice auction.

FIG. 2B illustrates a flow chart of another implementation of a method of conducting an electronic invoice auction.

FIGS. 3-9 are schematic graphs illustrating multiple invoices and multiple bids across multiple rounds in an electronic invoice auction.

FIG. 10 illustrates a flow chart of another implementation of a method of conducting an electronic invoice auction.

FIGS. 11-12 illustrate an example portion of a visual display for the bidder in an invoice auction, before and after receipt of a bid respectively.

FIG. 13 is a schematic diagram of an example of a generic computer system.

### DETAILED DESCRIPTION

In a conventional sealed bid auction, the bidders submit bids, and the bidder having the lowest bid wins the auction with the seller receiving the amount bid. A potential problem is that this may be perceived as unfair, in that the winning bid is lower than necessary for that bidder to have won over the other bidders. In a “clock auction” (also referred to as a “Dutch auction”), an auctioneer initially offers an item at a price in excess of the amount the seller expects to receive. The price is then lowered in steps until a bidder accepts the current price. That bidder wins the auction and pays that price for the item. Here a potential problem is that a clock auction may not work well when multiple items are being offered, and a given bidder cannot afford to bid on all items.

A technique to address these issues is to use an auction that includes aspects of both a clock auction and a knapsack allocation scheme. In particular, in the context of an invoice auction with multiple invoices in a lot, a bidder can offer both a minimum discount rate and a maximum amount to purchase. The discount rate is then reduced in steps from an initial discount rate until it is lower than the minimum discount rate of one of the bidders. The invoices are then allocated to maximize the total amount for this first winning bidder without exceeding the maximum offer of that first winning bidder. The auction can then continue, with the discount rate being reduced until it is lower than the minimum discount rate of another the bidders. Again, invoices are then allocated to maximize the total amount for this second winning bidder without exceeding the maximum offer of that second winning bidder. This process can iterate as needed until all invoices are sold.

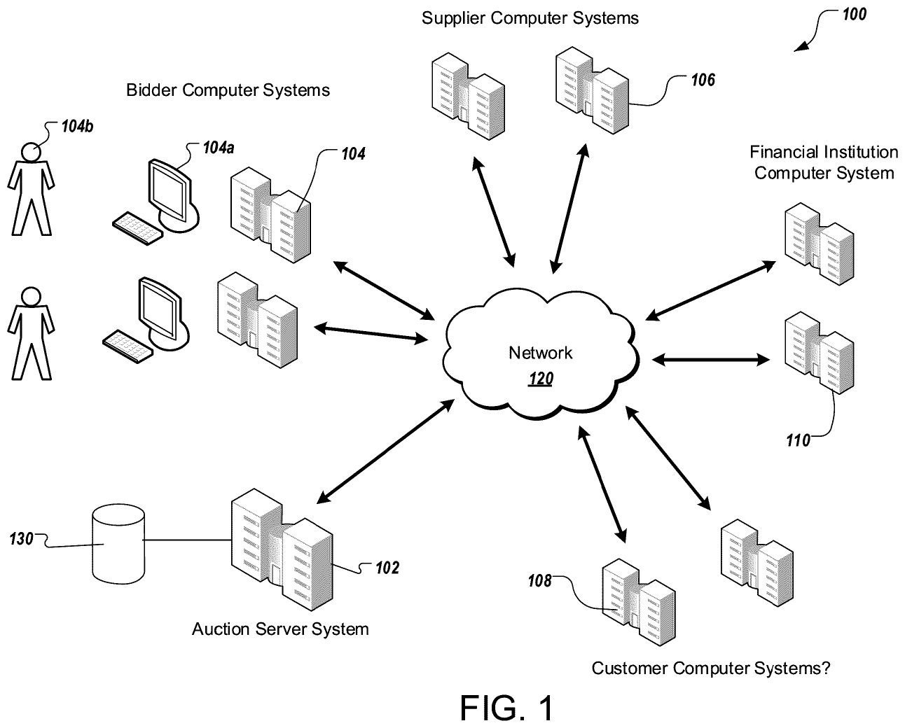

FIG. 1 illustrates an example system 100 used to conduct an auction, e.g., an invoice auction. An auction server system 102 is connected through a communications network 120, e.g., the Internet, at least to multiple bidder computer systems 104 and multiple supplier computer systems 106. Optionally, the auction server system 102 can be connected through the communications network 120 to one or more customer computer systems 108, and/or to one or more financial institution computer systems 110.

The auction server system 102 maintains a data store 130, e.g., one or more databases, that defines an account and stores account data for each respective participant in the auction, i.e., each bidder and each supplier and each customer. The account data includes a unique user ID for the respective participant, as well as the participant's name and contact information, e.g., the participant's address, telephone number, and email address, and the participant's password or PIN. The account data can also include financial information sufficient for the payment from the bidder to the supplier can be processed upon a successful bid, e.g., a name of a financial institution, account number, and bank routing number (also known as ABA number). Of course, the exact format or nature of financial information can depend on the country, e.g., accounts in Mexico may store a CLABE (Clave Bancaria Estandarizada) number. The financial information can be information for making payment (for the bidder at the acceptance of the bid and for the customer at the time the invoice is due) and for receiving payment (for the supplier at the acceptance of the bid and for the bidder at the time the invoice is due)

For the customers, the data store can store additional information that permits generation of a multi-axis score for each respective customer.

The suppliers are likely interested in registering with the auction server system 102 in order to be able to auction off invoices to quickly raise capital. The bidders are likely interested in registering with the auction server system 102 for the opportunity to make a time deferred profit, should their bid be successful, between the full amount of the invoice and the discounted amount (less an amount deducted for the auctioneer's commission). The customers should be pre-registered in the auction server system 102 so that the operator of the auction server system 102 can collect the customer information to provide a guide to the bidder on the risk level for the customer. A customer may be induced to register with the auction server system 102 by the supplier providing beneficial terms to the original invoice in return for the customer accepting that their invoices will be in the auction.

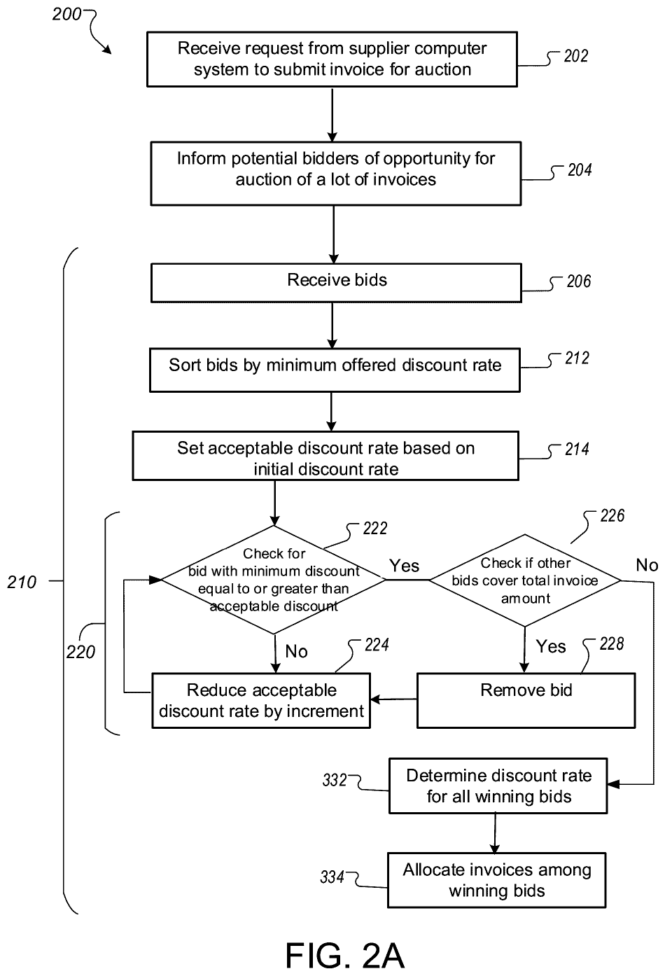

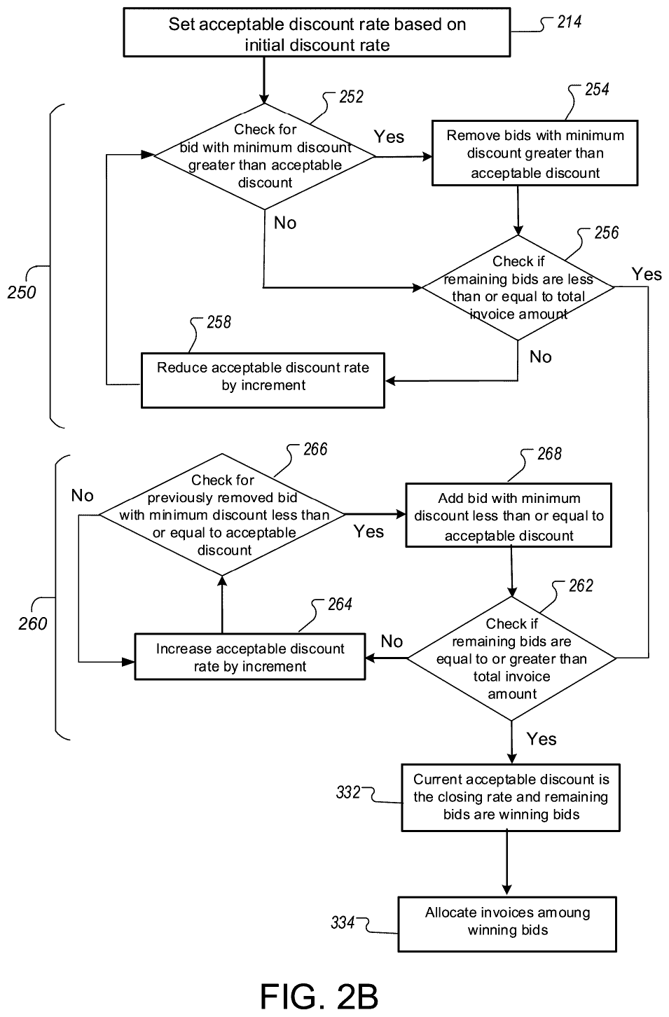

The auction server system 102 is configured to receive and recognize a request from a supplier computer system 106 to submit for auction a group of invoices (i.e., multiple invoices that form a “lot” of invoices) of the associated supplier (see step 202 in FIG. 2A). A variety of techniques to receive this request are possible. For example, a user of the supplier computer system 106 can use a general-purpose web-browser program, e.g., Internet Explorer or Chrome, to access a web-browser accessible website provided by the auction server system 106. As another example, the user of the supplier computer system 106 can run a dedicated application that is provided by the auction provider and configured for secure communication with the auction server system 102. As another example, the request can be sent and received by electronic mail, whose content may be interpreted by the auction server, thereby deriving appropriate invoice information for auction. The auction server system 102 collects the pertinent information regarding the invoice: the identity of the supplier, the identity of the customer, the amount of the invoice, and the payment deadline for the customer. The nature of the merchandise or services being invoiced may also be collected. This information can be extracted by auction server system 102 from an image of the invoice provided, e.g., uploaded by the supplier computer system 106 or attached to an email. For example, the auction server system 102 could perform optical character recognition (OCR) on an image of the invoice. Alternatively, the supplier computer system 106 may provide this information in tabular form as part of the request, e.g., the necessary information can be required from the user by the dedicated application before the request can be submitted.

The supplier also supplies, e.g., through the supplier computer system 106, a maximum acceptable discount rate.

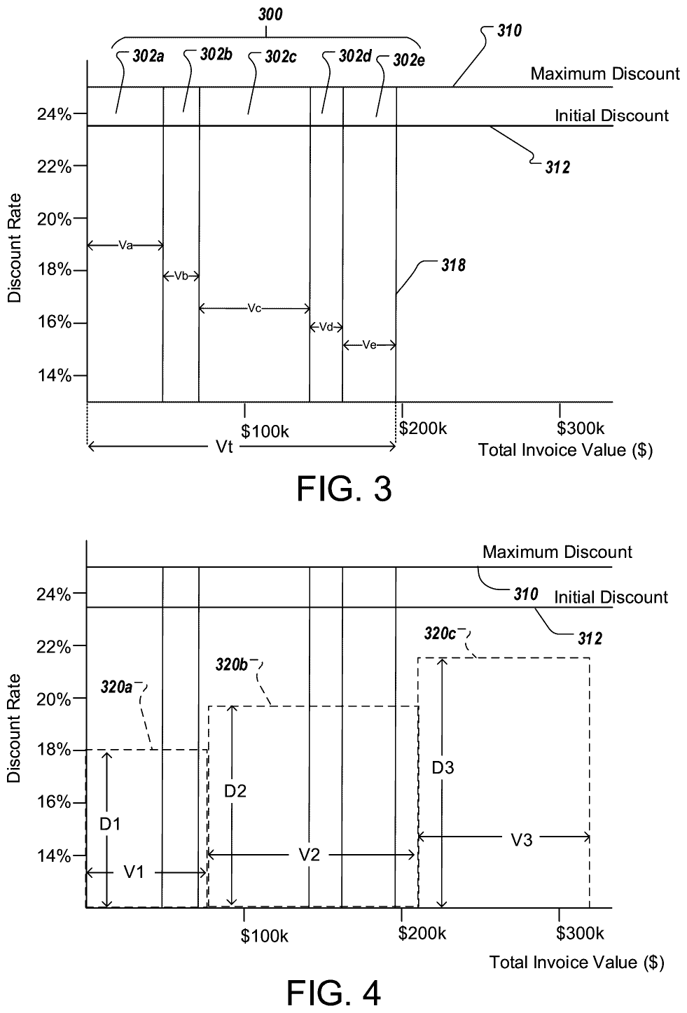

An example of the initial situation is illustrated in FIG. 3, which schematically shows a lot 300 of five invoices 302a-302c. Each individual invoice 302a-302e has an amount due (or value) Va-Ve, illustrated by the width of the respective column, with the lot 300 of invoices having a total value Vt at line 318. In this example, there are five invoices ranging in value from about $20k to about $90k, with a total value for the lot of just under $200k. However, this is simply illustrative: there could be a different number of invoices, different sets of values for the invoices, etc.

The maximum discount 310 acceptable to the supplier is shown by a horizontal line. In this example, the supplier has selected a maximum discount of 25%, but again, this is simply illustrative.

The auction server system 102 can calculate a “initial discount rate” 312. This will be the discount rate at which the auction server system starts, as discussed below. The difference between the supplier's maximum discount rate and the initial discount rate covers the commission for the auctioneer. In this example, the auctioneer has a 1.5% commission, so the initial discount rate is 23.5%, but again, this is simply illustrative.

A variety of techniques are possible for the bidder to participate in the auction. For example, a user 104b of the bidder computer system 104 can use a general-purpose web-browser program, e.g., Internet Explorer or Chrome, to access a web-browser accessible website provided by the auction server system 102. As another example, the user 104b of the bidder computer system 104 can run a dedicated application that is provided by the auction provider and configured for secure communication with the auction server system 102.

For the auction, the auction server system 102 sends a message out to each bidder computer system 104 that has indicated interest in receiving auctioned invoices (see step 204 in FIG. 2A). The message includes the pertinent information for the lot, e.g., the amount, term, identity of supplier, and identity of customer for each invoice in the lot. In general, in a lot with multiple invoices, each invoice will have the same: i) payment date, ii) buyer and iii) currency. This prevents mixed payment dates and mixed buyers in the same auction, so that the risk is uniform across the invoices in the lot. The message can also include a starting time for the auction. Typically the bids are solicited at least 24 hours before the auction begins.

The bidders 104b may select to review, or instruct the auction server system 102 to send, only certain invoices. For example, the auction server system 102 can implement a filter system that permits a bidder 104b to receive invoices within a certain size range, of type of good or service, within a certain term, etc.

For each bidder that chooses to participate, the bidder submits a bid to the auction server system (see step 206 in FIG. 2A). The bid includes a minimum discount rate and a maximum amount that the bidder is willing to cover. Optionally the bid could include a minimum amount that the bidder is willing to cover.

Once the designated starting time arrives, the auction 210 can begin.

The auction server system 102 can compare and prioritize the bids received from lowest minimum discount rate to the highest minimum discount rate (see step 212 in FIG. 2A). An example of the situation after sorting is illustrated in FIG. 4, which schematically shows three bids 320a-320c from three bidders. Each individual bid 320a-320c has a maximum amount covered V1-V3, illustrated by the width of the respective box, and a minimum discount rate D1-D3, illustrated by the height of the respective box. In this example, there are three bidders, with the lowest bid at 18%, the second lowest at 19.8%, and the highest at 21.8%. Again, this is simply illustrative: there could be a different number of bidders, different minimum discount rates and maximum amounts covered.

Referring now to FIG. 2A, an “acceptable minimum discount rate” is set equal to the initial discount rate (step 214). The auction server system 102 then begins a series of auction rounds (220). At each round, starting at the initial discount, the auction server system determines whether one of the remaining bidders has a minimum discount rate that is equal to or greater than the acceptable discount rate (222). If no such bidder exists, then the system reduces by acceptable discount rate by a bid increment (224). The system iterates these steps until such a bidder is found.

Once a bidder who has a minimum discount rate that is equal to or greater than the acceptable discount rate is found, the system determines whether total amount covered by the other bidders with lower minimum discount rates is sufficient to cover the total value Vt of the invoices (226). If the other bidders do have a total amount covered that covers the total value Vt of the invoices, the bidder with the highest minimum discount rate is eliminated from the auction (228).

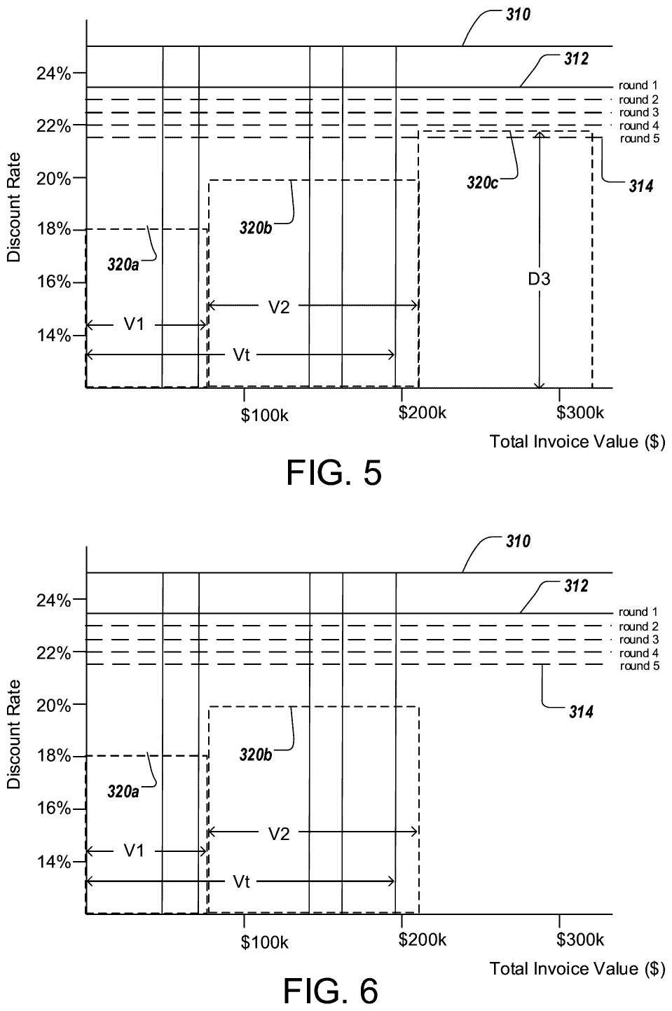

This is shown in FIGS. 5 and 6, where the acceptable discount rate 314 starts at the initial discount rate 312 at round 1. Then each subsequent round (rounds 2 through 5), the acceptable discount rate 314 is reduced by a set amount. The amount can be set by the auctioneer or the supplier, or can be calculated automatically by an algorithm in the auction server system. In the drawings the bid increment is shown as 0.5%, but in practice a larger or smaller amount can be used, e.g., anywhere from 0.0001% to 10%, e.g., 0.25%. In addition, rather than decrementing by a percentage, the bid increment could be a certain dollar value. Moreover, the bid increment could be calculated based on the granularity of the discount rates of the bids, the minimum and maximum allowable granularity that the auction permits, and the granularity that the supplier is willing to allow. At round 5, the third bid 320c has a minimum discount rate D3 which is higher than the current acceptable discount rate 314 for the round. However, the two remaining bids 320a, 320b, have a total amount covered (V1 plus V2) that is greater than the total value Vt of the invoices. Thus, the third bid 320c is eliminated.

Assuming a bidder is eliminated, the system reduces by acceptable discount rate by a bid increment (224) and the series of auction rounds is continued.

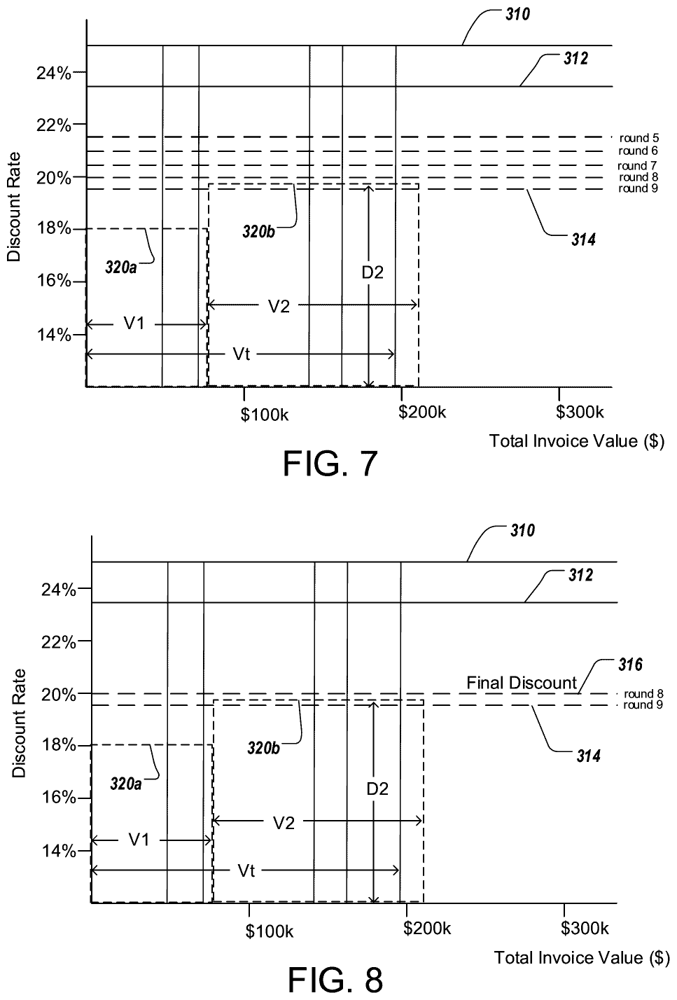

If the other bidders do not have a total amount covered that covers the total value Vt of the invoices, then the auction rounds are completed, with the remaining bids being considered as winning bids based on a criteria set by default, the auction administrator or based on certain criteria as selected by the seller. This is shown in FIG. 7, where at round 9 the acceptable discount rate 314 falls below the minimum discount rate D2 of the second bid 320b. However, if bid 320b were to be eliminated, then the total value (V1) of the remaining bid 320a would not cover the total value Vt of the invoices. Thus the first bid 320a and second bid 320b can be considered winning bids.

Next, the auction server system 102 determines a final discount rate (which can be referred to as a “pay-as-clear” discount rate) for the winning bids (332). In particular, the auction server system 102 finds the acceptable discount rate for the round immediately prior to the final round. This is equal to or greater than the minimum discount for the highest of the remaining bids. This is shown in FIG. 8, where the final discount 316 is set as the acceptable discount rate at round 8. All winning bids will receive this final discount rate. Thus, the bid with the lowest minimum discount rate actually receives a final discount significantly higher than its bid, e.g., 20% as opposed to 18%.

The auction server system 102 also allocates the invoices between the winning bids (334). This step could be switched with the determination of the discount rate. In some situations, no individual invoice in the lot 300 has a value equal to the maximum amount covered by any bid. Moreover, in some situations, combinations of invoices in the lot 300 still do not have a total value equal to the maximum amount covered by any bid. Therefore, some form of allocation is required.

To allocate the winning bids, the auction server system 102 uses a knapsack auction allocation algorithm. In particular, starting with the bid having the lowest discount rate, the auction server system 102 finds the combination of invoices that will be closest to, without exceeding, the maximum amount covered by that bid. This process iterates, each time allocating invoices to the bid next lowest discount rate, until all invoices are allocated. In some implementations, individual invoices are not “broken up” into partial values as this can result in complicated legal situation for collection in some jurisdictions. However, other implementations, individual invoices can be “broken up” into partial values. In any event, as a result, each bid is typically reduced, i.e., to the amount equal to the total value of the allocated invoices.

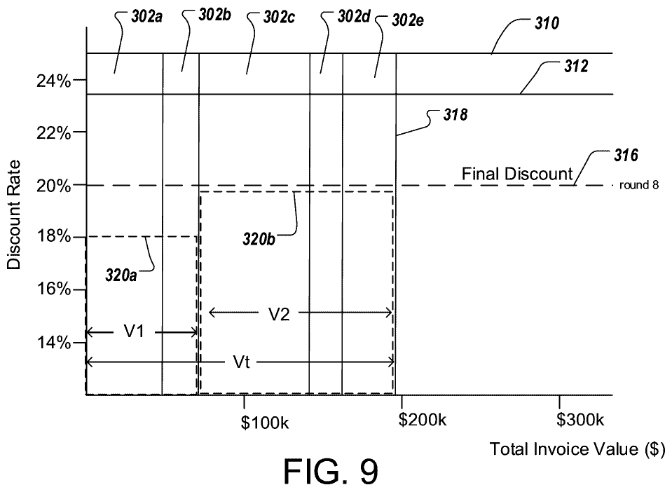

This is shown in FIG. 9, two invoices 302a and 302b are allocated to the first bid 320a, and three invoices 302c, 302d, 302e are allocated to the second bid 320b. As a result, the first bid 320a wins invoices totaling an amount (Va+Vb) that is as close to the maximum amount V1 as possible, given the possible combinations of invoices and without exceeding the maximum amount V1. The second bid 320b wins invoices totaling an amount (Vc+Vd+Ve), which is as close to the maximum amount V2 as possible, given the possible combinations of remaining invoices (i.e., excluding invoices already allocated) and without exceeding the maximum amount V2. As a result, the winning bid having the lowest minimum discount rate is most likely to receive closest to their maximum amount covered. The winning bid having the highest minimum discount rate could receive only a small portion of maximum amount covered.

In some situations, the knapsack algorithm may be initially unable to allocate all of the invoices. In this case, a new loop can be started, in which the acceptable minimum discount rate is incremented (rather than decremented) with each pass through the loop. After each increment, some bids (that have a minimum discount rate that falls within the new increased acceptable discount rate) can be added as winning bids. The knapsack algorithm is executed again, e.g., after each loop or each time a bid is added as a winning bid. If the knapsack algorithm is still unable to allocate the invoices, the loop is performed again. Once the knapsack algorithm is successful, the loop is exited.

At this point the auction is complete, and the auction server system 102 can send a report of the auction results to the participants. In particular, the auction server system 102 informs, e.g., by email, the bidder computer system of each winning bidder the amount that the winning bidder has to pay to the auctioneer. Winning bidders can have a set time, for example a 24 hour period to transfer the funds, in the meantime the auction server system 102 can send the promissory notes to the customer computer system if applicable. When the auctioneer receives the funds transfers them to the winning bidder, retaining its commission. A number of days before the payment date, the auction server system 102 sends a reminder to the customer computer system that payment is due. The number of days can be preset, e.g. from one to seven days, or calculated by the auction server system based on the size of the invoice, credit rating of the customer, etc. Presumably the customer pays the auctioneer, and the auctioneer transfers the funds to the winning bidders.

An alternative implementation for the iterative process 220 of FIG. 2A is shown in FIG. 2B. As before, an “acceptable minimum discount rate” is set equal to the initial discount rate (step 214). The auction server system 102 then begins a series of decrementing auction rounds (250). At each round, starting at the initial discount rate, the auction server system determines whether any of the remaining bids has a minimum discount rate greater than the acceptable discount rate (252). If such a bid exists, then the bid with a minimum discount rate greater than the acceptable discount rate are removed (254).

Once such a bid is removed, or if no such bid exists, then the auction server system 102 determines whether the total amount covered by the remaining bids with lower minimum discount rates is equal to or less than the total value Vt of the invoices (256). If the total amount covered by the remaining bids is greater than the total value Vt of the invoices, then the system decreases the acceptable discount rate by a bid increment (258). The process is iterated by returning to the step of checking for bids with minimum discount rate greater than the (now lower) acceptable discount rate (252).

If the total amount covered by the other bids is less than or equal to the total value Vt of the invoices, then the system 102 begins a series of incrementing auction rounds (260). Initially, the system 102 determine whether the total amount covered by the other bids is equal to or greater than the total value Vt of the invoices (262). If the total amount covered by the remaining bids is equal to or greater than the total value Vt of the invoices, then the iterative process is concluded, and the current acceptable discount rate is the closing rate and the remaining bids are winning bids (332).

However, if the total amount covered by the remaining bids is less than the total value Vt of the invoices, then the system 102 increases by acceptable discount rate by a bid increment (264). The bid increment used in the incrementing auction rounds (260) can be equal to or less than the bid increment used in the decrementing auction rounds (250).

Next, the auction server system 102 determines whether there is a previously removed bid (i.e., removed in step 254) with a minimum discount rate less than or equal to the adjusted acceptable discount rate (266). If no such bid exists, then the auction server system 102 iterates this process by again increasing the acceptable discount rate (264) and determining whether there is a previously removed bid with a minimum discount rate less than or equal to the adjusted acceptable discount rate (266).

If there is a previously removed bid with a minimum discount rate less than or equal to the adjusted acceptable discount rate, then that bid is added back into the remaining bids (268). Then the system 102 starts a round (260) again by returning to check whether the total amount covered by the other bids is equal to or greater than the total value Vt of the invoices (262).

The result is that the supplier gets the cash for invoices submitted better than any loosing bid (at or just above the lowest discount rate of the highest winning bid), and the winning bidders receive discount rates equal to or higher than their minimum discount rate.

As an alternative to the clock auction, an auction can be conducted as an “English auction” in which the bids are public, each bidder must make a bid greater than the prior bid, and the bid price increases until no bidder is willing to make a further bid. A potential problem is that in an invoice auction there are multiple invoices, and bidders may have a maximum amount covered which is less than the total value of all the invoices.

A technique to address this issue is to use a variant of an open English auction in which bidders are free to submit and change bids, and to display to the bidders a dual-axis representation of each bid.

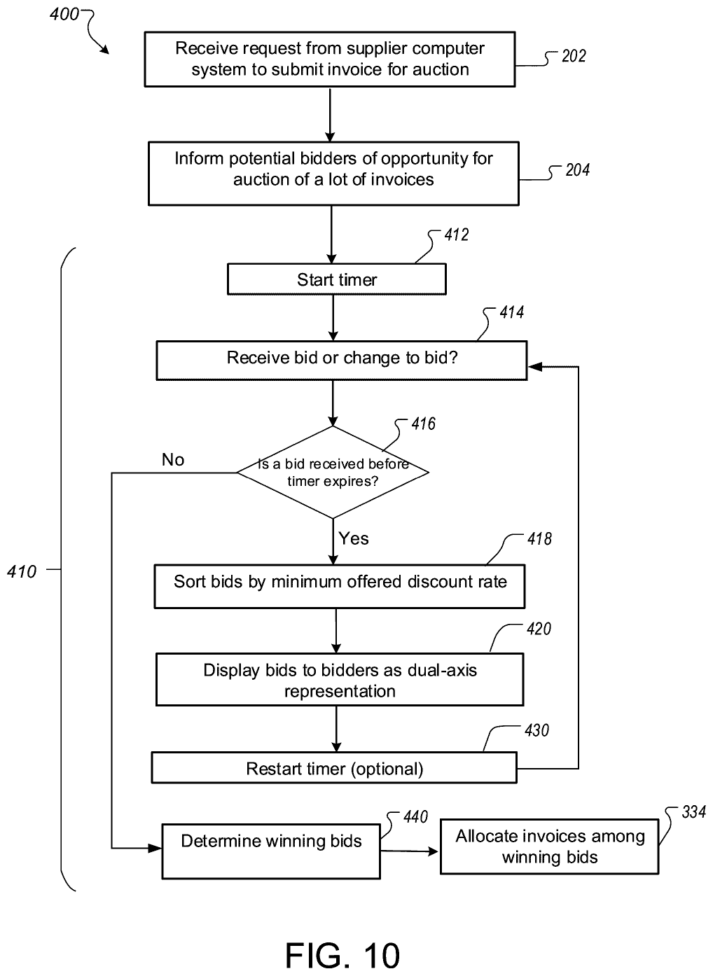

A method 400 for conducting an auction is shown in FIG. 10. The method begins similarly to the method 200 shown in FIG. 2A and described above, with the auction server system 102 receiving a request from a supplier computer system 106 to submit for auction a group of invoices (202), and sending a message out to each bidder computer system 104 that has indicated interest in receiving auctioned invoices (204).

Once the designated starting time arrives, the auction 410 can begin. In general, the auction server system 102 starts a countdown timer (412) with a preset duration, e.g., one hour to one day.

During this time, for each bidder that chooses to participate, the bidder can submit a bid to the auction server system, or change or remove an existing bid (414). The bid includes a minimum discount rate and a maximum amount that the bidder is willing to cover. Optionally the bid could include a minimum amount that the bidder is willing to cover.

The auction server system 102 monitors for the receipt of bids. Each time a bid is received while the timer has not expired (416), the auction server system compares and sorts the bids received from lowest minimum discount rate to the highest minimum discount rate (418).

In addition, the auction server system 102 communicates with the bidder computer systems, causing the display 104a for each bidder 104b to display a dual-axis representation of each currently outstanding bid (420) from all current bidders. As one example, if the bidder is using a general-purpose web-browser, then the auction server system 102 can generate HTML that when rendered by the general-purpose web-browser causes the two-axis score to be graphically displayed. As another example, if the bidder is using a dedicated application, then the dedicated application can be configured with code that causes the two-axis score to be displayed. In some implementations, the bidder computer systems cause the display 104a to show other information, e.g., financial metrics of the customer, the documents used by the auctioneer to verify the invoices, the amount of the accounts payable alive for the customer, the amount paid in the history by the customer.

In the representation of the bids displayed to the bidders, each bid can be shown as rectangular area in a graph, with one axis of the rectangular area providing the minimum discount an the other axis providing the maximum amount covered by the bid.

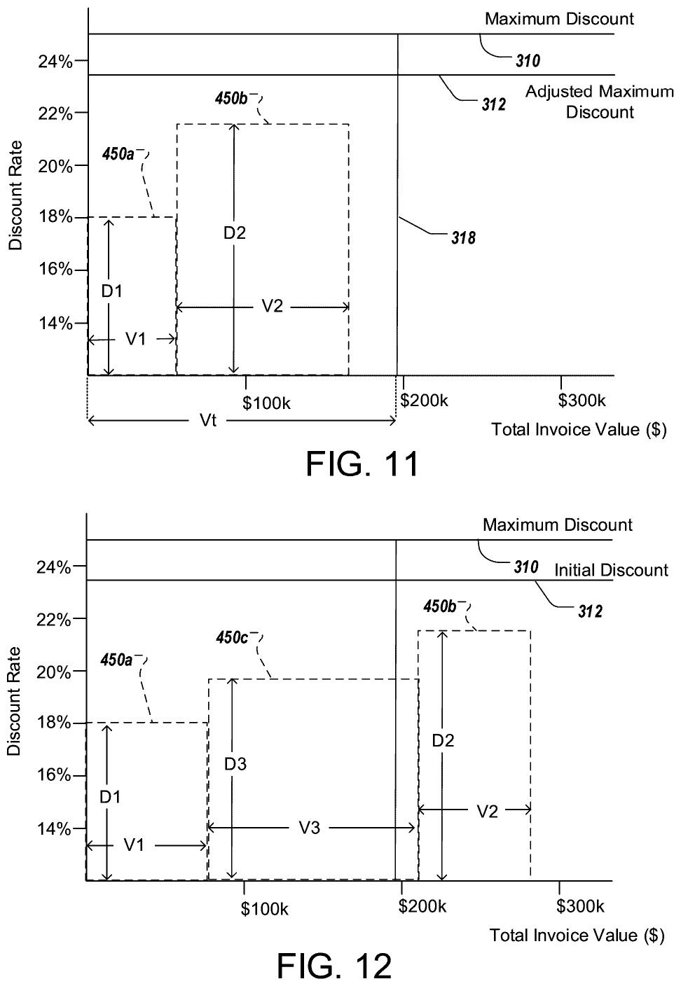

An example of a graph presented to a user on a display 104a after the receipt of two bids is illustrated in FIG. 11. In particular, FIG. 11 shows two bids 450a, 450b from two bidders. Each individual bid 450a, 450b has a maximum amount covered V1, V2, illustrated by the width of the respective box, and a minimum discount rate D1, D2, illustrated by the height of the respective box. In this example there are two bidders, with the lowest bid at 18%, the second bid at 21.8%, but this is simply illustrative: there could be a different number of bidders, different minimum discount rates and maximum amounts covered.

The bids are sorted and caused to be displayed along a line by the auction server system, e.g., along a horizontal axis on the display 104a with increasing discount rates. For example, if the bids are sorted from left to right, the bid having the lowest discount rate, e.g., bid 450a with discount rate D1, is leftmost. However, rather than sorting by increasing discount rate, the order along the axis can be based on other criteria, e.g. most recent bid, mort active bidder, largest amount bid, or fastest response time. In addition, in some implementations each bidder can set their selected sort order using their bidder computer system.

The auction server system can also cause the maximum discount rate 310, or an adjusted maximum discount rate 312, to be illustrated on the graph, e.g., as a horizontal line. The adjusted maximum discount rate 312 is the maximum discount rate 310 less the percentage taken by the auctioneer as commission.

The auction server system can also cause the total value Vt of the invoices to be illustrated on the graph, e.g., as a vertical line 318. In some implementations, value of each invoice can be illustrated, e.g., as a vertical line (similar to FIG. 3).

Referring to FIG. 12, upon receipt of a third bid 450c which could be a new bidder or a changed bid from a prior bidder, the bids are sorted again by the auction server system. Because the third bid 450c has a discount rate D3 that is between the discount rate D1 of the first bid 450a and the discount rate D2 of the second bid 450b, the auction server system causes the third bid 450c to be shown as slotted between the first and second bids 450a, 450b, along the axis.

Presenting the information in this way allows a bidder to quickly understand the other bids, and thus decide whether to submit or change a bid (changing a bid can be considered to be submitting a new bid and withdrawing an existing bid), thereby allowing the bidders to better set an appropriate discount rate to offer for the invoice.

Returning to FIG. 10, in some implementations the timer can be restarted after the receipt of each bid (430). Alternatively, the timer can simply run down to the predetermined end time of the auction.

Once the time expires, the winning bids based on the auction's set criteria can be determined (440). The bids having the lowest discount rate, while still summing to a total amount covered that is greater than the total value Vt of the invoices, are considered the winners. For example, as shown in FIG. 12, the first bid 450a and the third bid 450c would be considered the winning bids, as they have discount rates D1 and D3 that are lower than the discount rate D2 of the second bid 450b, while the total of value covered (V1+V3) that is greater than the total value (Vt) of the invoices.

A technique to determine the winning bids is to iterative sum the values covered by the bids, starting with the bid having the lowest discount rate and then moving to the bid with the next higher discount rate with each iteration. At each iteration, that sum can be compared to the total value (Vt) of the invoices. Once the sum exceeds the total value of the invoices, the iteration can stop; the bids which have been summed are the winning bids.

Next, the auction server system 102 can allocate the invoices between the winning bids (334). This can be performed as discussed above with reference to FIG. 2A.

At this point the auction is complete, and the auction server system 102 can send a report of the auction results to the participants, etc.

Although the description above focuses on invoice auctions, the auction can be generalized to handle other auctions where one axis (equivalent to the discount rate) is what is being bid upon, and the other axis (equivalent to the maximum value) is the maximum resources the bidder is willing to commit. Moreover, broadening out the dual axis notion, the invoice may be a two dimensional contracted commitment and/or a mean to define the auction parameters (the implementation above is a variable discount rate and a set amount of time) and the bidding can be related to either of those two dimensions. For example, the payment could be fixed, and the time of payment could be the variable being bid upon. For example, assuming a contracted invoice is for ten workers three weeks from now, bidders could compete by bidding ten workers sooner, or bidding more workers in three weeks.

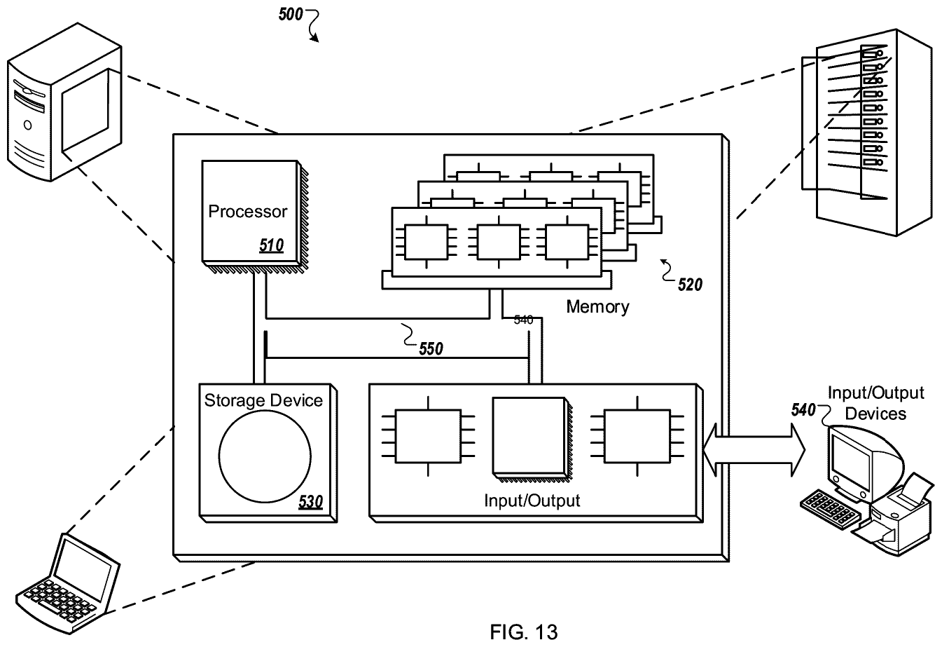

FIG. 13 is a schematic diagram of an example of a generic computer system 500. The system 500 can be used for any of the operations described above. For example, a system 500 may provide each of any or all of the auction provider server system 102, the bidder computer system 104, the supplier computer system 106, or the customer computer system 108.

The system 500 includes a processor 510, a memory 520, a storage device 530, and an input/output device 540. Instructions that implement operations associated with the methods described above can be stored in the memory 520 or on the storage device 530. Each of the components 510, 520, 530, and 540 are interconnected using a system bus 550. The processor 510 is capable of processing instructions for execution within the system 500. In some implementations, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a non-volatile memory unit.

The storage device 530 is capable of providing mass storage for the system 500. In some implementations, the storage device 530 is a computer-readable medium. In various different implementations, the storage device 530 may be a floppy disk device, a hard disk device, an optical disk device, or a tape device.

The input/output device 540 provides input/output operations for the system 500. In some implementations, the input/output device 540 includes a keyboard and/or pointing device. In another implementation, the input/output device 540 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. The computer storage medium can be a machine-readable storage device, a machine-readable storage substrate, a random or serial access memory device, or a combination of one or more of them. Alternatively or in addition to being encoded on a storage medium, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. One or more non-transitory computer-readable media storing instructions that, when executed by one or more computers of a computer system, cause the one or more computers to:
maintain at least one data store defining a respective account for each of a plurality of suppliers, each of a plurality of customers, and each of a plurality of bidders;
receive from a supplier computer system a request to submit one or more invoices for auction;
calculate a total invoice amount for the one or more invoices;
receive a plurality of bids from a plurality of bidder computer systems, each bid including a minimum discount rate and a maximum amount covered;
set an acceptable discount rate equal to an initial discount rate;
set a remaining group of bids to be the plurality of bids;
at a close of bidding, in an iterative loop
determine whether any bid from the remaining group of bids has a minimum discount rate equal to or greater than the acceptable discount rate,
if no bid is determined to have a minimum discount rate greater than the acceptable discount rate, then decrement the acceptable discount rate by a bid increment, and repeat the loop,
if a given bid is determined to have a minimum discount rate equal to or greater than the acceptable discount rate, then
calculate a total amount covered by summing the maximum amount covered of each bid, other than the given bid, of the remaining group of bids,
determine whether the total amount covered is equal to or greater than the total invoice amount, remove the given bid from the remaining group of bids,
if the total amount covered is determined to be equal to or greater than the total invoice amount, then decrement the acceptable discount rate by the bid increment, and repeat the loop,
if the total amount covered is determined to be less than the total invoice amount, then exit the loop;
allocate the invoices among the one or more bids of the remaining group of bids; and
set a final discount rate to be the acceptable discount rate.

2. The non-transitory computer-readable media of claim 1, wherein the instructions to allocate the invoices comprise a knapsack algorithm.

3. The non-transitory computer-readable media of claim 2, comprising instructions to determine whether the knapsack algorithm is unable allocate the invoices.

4. The non-transitory computer-readable media of claim 2, comprising instructions to, if the knapsack algorithm is determined to be unable to allocate the invoices, then in a second iterative loop,
increase the acceptable discount rate,
determine whether the knapsack algorithm is able to allocate the invoices among the remaining group of bids,
if the knapsack algorithm is determined to be unable to allocate the invoices among the remaining group of bids, repeat the loop,
if the knapsack algorithm is determined to be able to allocate the invoices among the remaining group of bids, exit the loop.

5. The non-transitory computer-readable media of claim 1, comprising instructions to sort the plurality of bids by minimum discount rate.

6. The non-transitory computer-readable media of claim 1, comprising instructions to send to each of the plurality of bidder computer systems a message comprising an identity of the customer, a common due date for the one or more invoices, and an amount due for each of the one or more invoices.

7. The non-transitory computer-readable media of claim 1, wherein the message includes a time of close of bidding.

8. The non-transitory computer-readable media of claim 1, comprising instructions to, for each given remaining bid, to send a corresponding bidder computer systems a message comprising the final discount rate and any invoice allocated to the given remaining bid.

9. One or more non-transitory computer-readable media storing instructions that, when executed by one or more computers of a computer system, cause the one or more computers to:
maintain at least one data store defining a respective account for each of a plurality of suppliers, each of a plurality of customers, and each of a plurality of bidders;
receive from a supplier computer system a request to submit one or more invoices for auction;
receive a plurality of bids from a plurality of bidder computer systems, each bid including a minimum discount rate and a maximum amount covered; and
for each respective bidder of one or more bidders from the plurality of bidders, cause a display of a bidder computer system of the respective bidder to display a dual-axis representation of a multiplicity of currently outstanding bids, the dual axis representation including a first axis representing a discount rate and a second axis representing the maximum amount covered.

10. The non-transitory computer-readable media of claim 9, comprising instructions to cause the display of the bidder computer system to display dual-axis representations as rectangles having distance along the first axis corresponding to the discount rate and a second distance along the second axis corresponding to the maximum amount covered.

11. The non-transitory computer-readable media of claim 9, comprising instructions to cause the display of the bidder computer system to display dual-axis representations of the multiplicity of currently outstanding bids in a sequence along the second axis.

12. The non-transitory computer-readable media of claim 11, comprising instructions to cause the display of the bidder computer system to display dual-axis representations as rectangles having distance along the first axis corresponding to the discount rate and a second distance along the second axis corresponding to the maximum amount covered.

13. The non-transitory computer-readable media of claim 12, comprising instructions to cause the display of the bidder computer system to display the rectangles as abutting.

14. The non-transitory computer-readable media of claim 9, wherein the first axis is a vertical axis and the second axis is a horizontal axis.

15. One or more non-transitory computer-readable media storing instructions that, when executed by one or more computers of a computer system, cause the one or more computers to:
maintain at least one data store defining a respective account for each of a plurality of suppliers, each of a plurality of customers, and each of a plurality of bidders;
receive from a supplier computer system a request to submit one or more invoices for auction;
calculate a total invoice amount for the one or more invoices;
receive a plurality of bids from a plurality of bidder computer systems, each bid including a minimum discount rate and a maximum amount covered;
set an acceptable discount rate equal to an initial discount rate;
set a group of remaining bids to be the plurality of bids;
at a close of bidding, in a first iterative loop
determine whether a bid from the group of remaining bids has a minimum discount rate greater than the acceptable discount rate, and if a given bid is determined to have a minimum discount rate equal to or greater than the acceptable discount rate, then remove the given bid from the group of remaining bids,
calculate a total amount covered by summing the maximum amount covered of each bid of the group of remaining bids,
determine whether the total amount covered is equal to or less than the total invoice amount,
if the total amount covered is determined to be greater than the total invoice amount, then decrease the acceptable discount rate by a first bid increment, and repeat the loop,
if the total amount covered is determined to be less than or equal to the total invoice amount, then exit the first loop;
allocate the invoices among the one or more bids of the remaining group of bids; and
set a final discount rate to be the acceptable discount rate.

16. The non-transitory computer-readable media of claim 15, comprising:
if the total amount covered is determined to be less than or equal to the total invoice amount, then start a second iterative loop including
calculate a total amount covered by summing the maximum amount covered of each bid of the group of remaining bids,
determine whether the total amount covered is equal to or greater than the total invoice amount,
if the total amount covered is determined to be equal to or greater than the total invoice amount, then exit the second loop and proceed to allocate the invoices,
if the total amount covered is determined to be less than the total invoice amount, then increase the acceptable discount rate by a second bid increment,
determine whether a previously removed bid has a minimum discount rate less than or equal to the acceptable discount rate,
if a previously removed bid is not determined to have a minimum discount rate less or equal to the acceptable discount rate, then increase the acceptable discount rate by a second bid increment,
if a previously removed bid is determined to have a minimum discount rate less than or equal to the acceptable discount rate, add the previously removed bid back to the group of remaining bids and repeat the loop.

17. The non-transitory computer-readable media of claim 16, wherein the second increment is less than the first increment.

18. The non-transitory computer-readable media of claim 16, wherein the second increment is equal to the first increment.
